(19) United States
(12) Patent Application Publication
(10) Pub. No.: US 2024/0110586 A1
(43) Pub. Date: Apr. 4, 2024

(54) MODULAR ADHESIVE ANCHOR SCREEN

(71) Applicant: Simpson Strong-Tie Company Inc., Pleasanton, CA (US)

(72) Inventors: Joel Houck, Cedar Lake, IN (US); Vuong Phan, Ho Chi Minh City (VN)

(73) Assignee: Simpson Strong-Tie Company Inc., Pleasanton, CA (US)

(21) Appl. No.: 18/466,302

(22) Filed: Sep. 13, 2023

Related U.S. Application Data
(60) Provisional application No. 63/407,280, filed on Sep. 16, 2022.

(51) Int. Cl. F16B 5/08

(52) U.S. Cl. CPC F16B 5/08

(57) ABSTRACT

A modular adhesive insert for a construction anchor allows for controlled dispersion of adhesive in a pre-formed bore, and multiple insert screens to be attached to each other to create many sizes of screens. The insert comprises an end cap and also includes an abutment structure. The insert includes a housing with a first end and a second end, the first end including a first set of connection structures, the second end including a second set of connection structures, the housing including a plurality of shutters between the first end and the second end, each of the shutters adapted to vary a size of an opening associated with each said shutter.

### CLAIM OF PRIORITY

This application claims priority to U.S. Provisional Patent Application No. 63/407,280, entitled “MODULAR ADHESIVE ANCHOR SCREEN”, filed Sep. 16, 2022, which application is incorporated by reference herein in its entirety.

### BACKGROUND

Apertured sleeves are used in various cases when setting an adhesive construction anchor in the face of a wall or other foundation material. An adhesive anchor should be completely surrounded by the adhesive or mortar, and the adhesive should completely fill the space between the anchor and the wall of the bore. Currently, screen tubes or plastic screens retain the adhesive and prevent it from falling into the hollow cavity in the base material during installation. The adhesive flows out of the screen or tube when the anchor is inserted into the screen, and bonds with the solid parts of the base material.

Apertured sleeves are also useful when the anchor is set in a hollow substrate or a substrate with an internal open space or spaces such as bricks, concrete blocks, or concrete masonry units (CMU). The screen-type insert serves to keep the adhesive close to the anchor. Setting an anchor in a substrate having interior voids creates further difficulties for the insertion of adhesives. Not only can the adhesive flow too far into the bore away from the anchor, and drip down from the upper surfaces of the bore, but it can literally fall into the void completely away from the anchor.

Concrete blocks are generally cement and/or concrete formed into rectangular cells. Concrete blocks and concrete masonry units are hollow rather than solid rectangular blocks. A typical concrete block or CMU is generally a rectangular block with 4 full sides or shells surrounding a cavity that opens outwardly through the top and bottom surfaces. Wider concrete blocks and concrete masonry units may be formed with a web that divides the cavity and spans the distance from one side of the block to the other. The walls of the concrete block or CMU can be narrow or thicken depending on the strength needed for the block.

One issue that arises with the use of apertured sleeves is that different sizes of apertures need to be provided for different types of adhesives. Because of multiple components and assembly process, current plastic screens have become very expensive. Limited suppliers of the mesh tubes also raised potential supply chain disruptions, and the screens are only available in limited lengths due to the low volumes and need to make a new mold for each length. Builders thus may have to purchase apertured sleeves or screens that are not optimized for the length of their application because of a limited length selection. In addition, a different aperture size is generally needed for each different adhesive due to differences in adhesive chemistry, including different particle sizes and viscosities.

### SUMMARY

The technology relates to an improved connection between an anchor or fastening element in a substrate, such as masonry, cement, or stone, using an adhesive or mortar compound to make the connection, and more particularly, provides an improved apertured or porous sleeve-shaped member for use with the anchor and the adhesive.

One general aspect includes a modular adhesive insert for a construction anchor. The insert comprises a first plastic insert comprising housing with a first end and a second end, the first end including a first set of connection structures. The second end includes a second set of connection structures. The first set of connection structures are adapted to connect to the second set of connection structures of a second plastic sleeve, and the body includes a plurality of shutters between the first end and the second end.

Implementations may include the insert where the plastic insert includes a plurality of apertures coincident with the shutters. Implementations may include the insert further including a first end cap and a second end cap, the first set of connection structures adapted to connect to the first end cap and the second set of connection structures adapted to connect the second end cap to the plastic sleeve. Implementations may include the insert where each shutter has at least an open side, a second side opposing the open side and two sides defined by an indentation in the housing and positioned between the open side and second side.

Implementations may include the insert where each shutter has at least a hinged side, a free end opposing the hinged side, and two free sides between the hinged side and the free end. Implementations may include the insert where each of the plurality of shutters includes the hinged side perpendicular to a central axis of the screen such that each shutter opens along an axial length of the screen. Implementations may include the insert where each of the plurality of shutters includes the hinged side parallel to a central axis of the screen such that each shutter opens along a radial length of the screen. Implementations may include the insert where each of the plurality of shutters includes an interior side and an exterior side, and a cam on the interior side of the shutter. Implementations may include the insert where each of the plurality of shutters includes and interior side and an exterior side, and a cam on the exterior side of the shutter. Implementations may include the insert wherein the screen includes a plurality of panels interleaved with the plurality of shutters, and wherein ones of the panels and ones of the shutters include apertures. Implementations may include the insert where the first set of connection structures may include posts. Implementations may include the insert where the second set of connection structures may include notches.

Another aspect includes A modular adhesive screen for an anchor insert assembly for use in a bore in a substrate. The screen includes a body having a first end and a second end, and a length between the first end and the second end. The body has a tubular shape defined by one or more outer surfaces, the one or more outer surfaces including a plurality of shutters, each of the shutters configured to vary an opening associated with the shutter upon installation of the insert assembly.

Implementations may include the screen where the shutters vary in size as the screen is inserted into the bore. Implementations may include the screen where each of the plurality of shutters includes and interior side and an exterior side, and a cam on the exterior side of the shutter. Implementations may include the screen wherein the anchor insert assembly includes an anchor rod inserted into the screen, and the shutters vary in size as the anchor rod is inserted into the screen. Implementations may include the screen each of the plurality of shutters includes an interior side and an exterior side, and a cam on the interior side of the shutter. Each of the plurality of shutters has at least a hinged side, a free end opposing the hinged side, and two free sides between the hinged side and the free end. Implementations may include the screen each of the plurality of shutters includes the hinged side perpendicular to a central axis of the screen such that each shutter opens along an axial length of the screen. The screen includes a plurality of panels interleaved with the plurality of shutters, and where ones of the panels and ones of the shutters include apertures.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

Aspects of the present disclosure are illustrated by way of example and are not limited by the accompanying figures for which like references indicate like elements.

FIG. 1 is a perspective view of a prior art aperture screen for use with an adhesive anchor.

FIG. 2A is a sectional front view of the insert of FIG. 1 being filled with adhesive.

FIG. 2B is a sectional front view of the insert of FIG. 1 being filled with adhesive.

FIG. 2C is a sectional front view of the insert of FIG. 1 filled with adhesive and inserted through two oppositely disposed shells of a hollow concrete masonry unit.

FIG. 2D is a sectional front view of the insert of FIG. 1 filled with adhesive and inserted through two oppositely disposed shells of a substrate with an inserted anchor so that the adhesive is forced out of the apertures in the insert to bond with the shells of the concrete masonry unit.

FIG. 2E is a sectional front view of the insert of FIG. 1 filled with adhesive inserted through one shell of a hollow concrete masonry unit.

FIG. 3A is perspective view of a first embodiment of an adhesive screen used in a modular adhesive anchor insert in accordance with the present technology.

FIG. 3B is a plan view of the first embodiment of an adhesive screen and accompanying endcaps which comprise a modular adhesive anchor insert in accordance with the present technology.

FIG. 3C is a cutaway view along line 3C-3C of FIG. 3A.

FIG. 3D is a partial, enlarged, cutaway view along line 3D-3D of FIG. 3D.

FIG. 3E is a view along line 3E-3E of FIG. 3A.

FIG. 4A is a perspective view of a second embodiment of an adhesive screen used in a modular adhesive anchor insert in accordance with the present technology.

FIG. 4B is a plan view of the second embodiment of an adhesive screen portion of a modular adhesive anchor insert in accordance with the present technology.

FIG. 4C is a view along line 4C-4C of FIG. 4A.

FIG. 4D is a perspective, cutaway view along line 4D-4D of FIG. 4A.

FIG. 4E is a partial, enlarged, cutaway view along line 4E-4E of FIG. 4D.

FIG. 5 is a perspective, cutaway view of an anchor entering the embodiment of the adhesive anchor of FIGS. 4A-4E illustrating movement of the axial shutters.

FIG. 6A is a perspective view of a third embodiment of an adhesive screen used in a modular adhesive anchor insert in accordance with the present technology.

FIG. 6B is a plan view of the third embodiment of an adhesive screen portion of a modular adhesive anchor insert in accordance with the present technology.

FIG. 6C is a view along line 6C-6C of FIG. 6A.

FIG. 6D is a view along line 6D-6D of FIG. 6A.

FIG. 6E is a partial, enlarged, cutaway view along line 6E-6E of FIG. 6D.

FIG. 6F is a view along line 6F-6F of FIG. 6A.

FIG. 7A is a perspective view of a fourth embodiment of an adhesive screen used in a modular adhesive anchor insert in accordance with the present technology.

FIG. 7B is a plan view of the fourth embodiment of an adhesive screen portion of a modular adhesive anchor insert in accordance with the present technology.

FIG. 7C is a view along line 7C-7C of FIG. 7A.

FIG. 7D is a view along line 7D-7D of FIG. 7A.

FIG. 7E is a partial, enlarged, cutaway view along line 7E-7E of FIG. 7D.

FIG. 8A is a perspective view of a fourth embodiment of an adhesive screen used in a modular adhesive anchor insert in accordance with the present technology.

FIG. 8B is a plan view of the fourth embodiment of an adhesive screen portion of a modular adhesive anchor insert in accordance with the present technology.

FIG. 8C is a view along line 8C-8C of FIG. 8A.

FIG. 8D is a view along line 8D-8D of FIG. 8A.

FIG. 8E is a cutaway view along line 8E-8E of FIG. 8A.

FIG. 8F is a partial, enlarged, cutaway view along line 8F-8F of FIG. 8D.

FIG. 9A is a cutaway view the anchor of FIG. 8A-8F inserted through two oppositely disposed shells of a hollow concrete masonry unit.

FIG. 9B is a top view the anchor of FIGS. 8A-8F inserted through two oppositely disposed shells hollow concrete masonry units.

FIG. 10A is a perspective view of a fourth embodiment of an adhesive screen used in a modular adhesive anchor insert in accordance with the present technology.

FIG. 10B is a plan view of the fourth embodiment of an adhesive screen portion of a modular adhesive anchor insert in accordance with the present technology.

FIG. 10C is a view along line 10C-10C of FIG. 10A.

FIG. 10D is a view along line 10D-10D of FIG. 10A.

FIG. 10E is a perspective, cutaway view along line 10E-10E of FIG. 10A.

FIG. 11A is a cutaway view of the anchor of FIGS. 10A-10E inserted through two oppositely disposed shells of a hollow concrete masonry unit.

FIG. 11B is a top view the anchor of FIGS. 10A-10E inserted through two oppositely disposed shells hollow concrete masonry units.

FIG. 12A is a prospective view of a fourth embodiment of an adhesive screen used in a modular adhesive anchor insert in accordance with the present technology.

FIG. 12B is a plan view of the fourth embodiment of an adhesive screen portion of a modular adhesive anchor insert in accordance with the present technology.

FIG. 12C is a view along line 12C-12C of FIG. 12A.

FIG. 12D is a view along line 12D-12D of FIG. 12A.

FIG. 12E is a perspective, cutaway view along line 12E-12E of FIG. 12A.

FIG. 12F is a partial, enlarged, cutaway view along line 12F-12F of FIG. 12A.

FIG. 12G is a partial, enlarged, cutaway view along line 12G-12G of FIG. 12B.

FIG. 13A is a perspective view of a fourth embodiment of an adhesive screen used in a modular adhesive anchor insert in accordance with the present technology.

FIG. 13B is a plan view of the fourth embodiment of an adhesive screen portion of a modular adhesive anchor insert in accordance with the present technology.

FIG. 13C is a view along line 13C-13C of FIG. 13A.

FIG. 13D is a view along line 13D-13D of FIG. 13A.

FIG. 13E is an enlarged view of the end portion illustrated in FIG. 13A.

### DETAILED DESCRIPTION

The present technology roughly described provides an improved insert for use in adhesively securing construction anchors in a substrate. The insert is a modular adhesive insert for a construction anchor that allows multiple insert screens to be attached to each other to create various sizes of screens, and which is created by a relatively simple injection molding process to provide different variations of insert which can be used with multiple types of adhesives. The insert comprises an end cap and also includes an abutment structure (or second end cap). The insert includes a plastic insert having a first end and a second end, the first end including a first set of connection structures such as posts, and the second end including a second set of connection structures such as notches. The first set of connection structures is adapted to connect the end cap to the plastic sleeve, and the second set of connection structures is adapted to connect the abutment structure portion to the plastic sleeve. The first set of connection structures is further adapted to connect the first end of the plastic insert to the second set of connection structures on a second plastic sleeve.

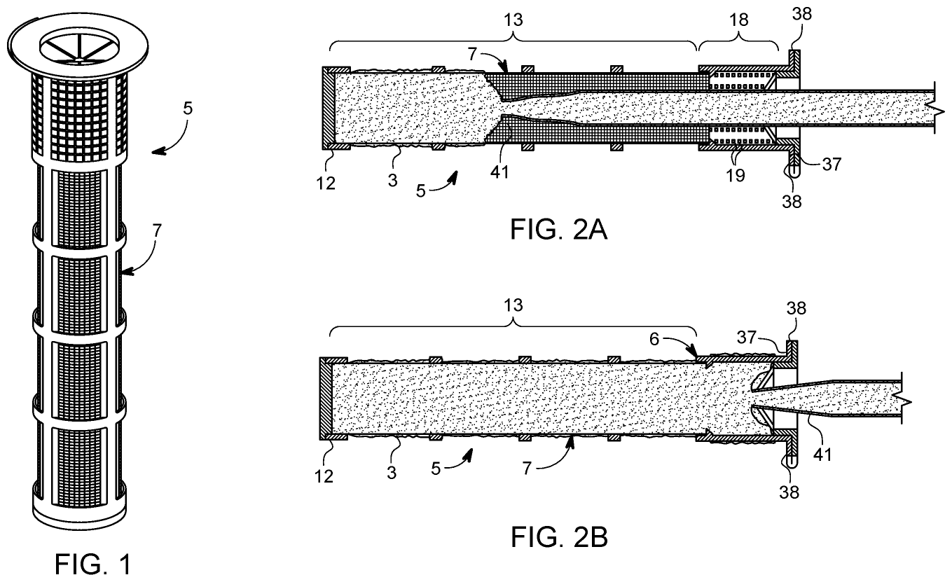

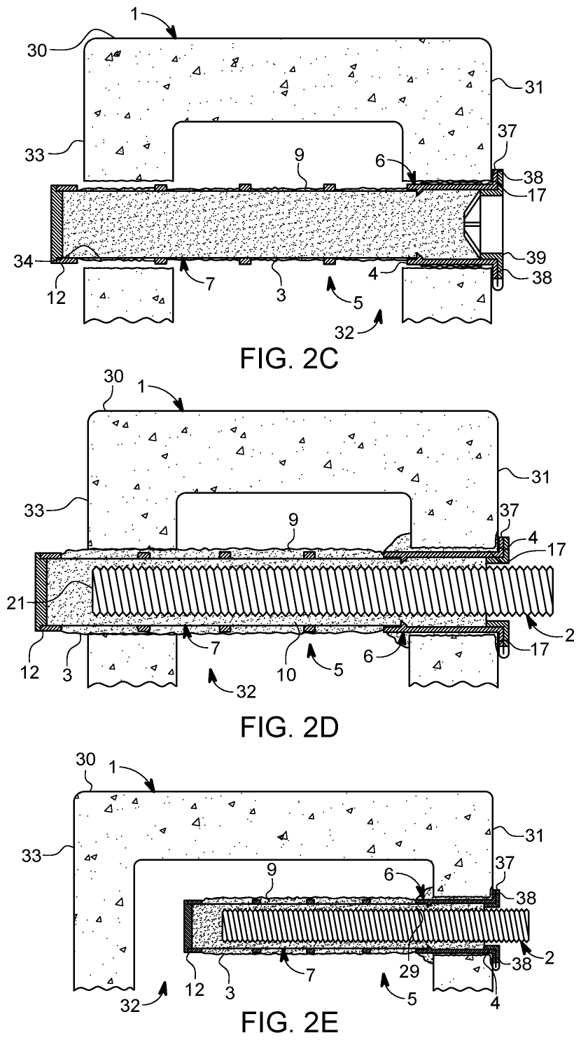

FIGS. 1 and 2A-2E show an apparatus and a method of forming a connection, between a substrate 1 and an anchor 2 by means of adhesive 3. FIGS. 1 and 2A-2E are reproduced from U.S. Pat. No. 7,837,018.

A substrate 1 is first formed with a bore 4 therein. To facilitate the connection between the anchor 2 and the substrate 1 a porous screen 5 is used. Screen 5 is received by bore 4 in substrate 1. Screen 5 is formed from a frame 7 and a tube 7. A distal end 12 of frame 7 is inserted first into the bore and a trailing or anchor receiving end 15 is visible when the screen 5 is inserted into the bore 4. The leading axial section 13 of the frame 7 is formed with apertures 14 and tube 7 has apertures 17 formed therein.

The tube 7 is received by frame 7, such that at least a portion of the tube 7 overlaps a portion of the leading axial section 13. Because there are apertures 14 in the leading axial section 13 and apertures 17 in the tube 7, a fluid material disposed within the interior area 8 enclosed by frame 7 and at the leading axial section 13 could be forced radially outwardly through the apertures 17 in the tube 7, and through the apertures 14 in the leading axial section 13 of the frame 7 to reach the exterior 9 of the frame 7.

As shown in FIGS. 2A and 2B, an injection gun is typically used for filling an adhesive into the tube 7 and the screen 5 can be filled with a cap 39 having an opening for receiving the nozzle 41 of an injection gun in place if desired. The adhesive 3 is disposed within the interior area 8 of the frame 7 and the adhesive 3 is forced out of the frame 7 through the apertures 17 in the tube 7 and the apertures 14 in the axial section 13 of the frame 7.

As shown in FIGS. 2C and 2D, when the substrate comprises a concrete masonry unit or other hollow substrate 30, and the user desires to set the anchor in both a first web 31 and a second web 33 of the substrate 30, the screen 5 needs to be stiff enough, when filled with adhesive 3, to be inserted into a first bore 4 formed in a first web 31 of a hollow substrate 30, extend across an interior cavity 32 of the hollow substrate 30, and be received in second aperture formed in the second, opposite web 33 of the hollow substrate 30.

As shown in FIGS. 2C-2E, the screen has an outer diameter 35 selected to cooperate with the diameter of the bore 4 or aperture in the substrate 1 or the first and second bores 4 and 34 in the first web 31 and second web 33 of a hollow substrate 30. When a fastener or anchor 2 is inserted into the cylindrical screen 5, the adhesive 3 is disposed within the screen 5 will be prevented from being axially discharged from the distal end 12 of the screen 5, and will be discharged radially through the apertures 14, 17 and 19 in the screen 5 as illustrated in FIGS. 2D and 2E.

As shown in FIG. 2D, frame 7 is formed with an abutment structure 37 at its anchor receiving end 15 which determines the depth to which the screen 5 can be driven or inserted into the bore 4. This abutment structure 37 may be formed by providing an annular flange at the anchor receiving end 15, or as is shown in FIG. 1, in the embodiment, a pair of oppositely disposed flanges 38 at the anchor receiving end 15 of the frame 7.

With respect to the adhesive 3, the apertures 17 in the mesh tube 7 and the apertures 19 in the second axial section 18 are designed to be used with a specific adhesive 3. The characteristics of the adhesive 3 determine the size of the apertures 17 of the mesh tube 7 and the size of the apertures 19 in the second axial section 18 of the frame 7.

For a hollow substrate, such a substrate 30, the substrate is prepared by forming aligned bores 4 and 34 in the first web 31 and second web 33 of the hollow substrate 30. Using a drill, a first bore 4 is formed in the first web 31 of the substrate 30. The drill is then inserted further, extending across the interior cavity 32 of the hollow substrate 30, and a second bore 34 is blind drilled in a second, opposite web 33 of the hollow substrate 30.

The solution shown in FIGS. 1-2E requires multiple components and assembly, and have thus become very expensive over the years, which is the opposite of how they were intended. In addition, a different screen mesh is needed for each different adhesive due to differences in adhesive chemistry. Embodiments of the modular adhesive anchor disclosed herein address these and other issues.

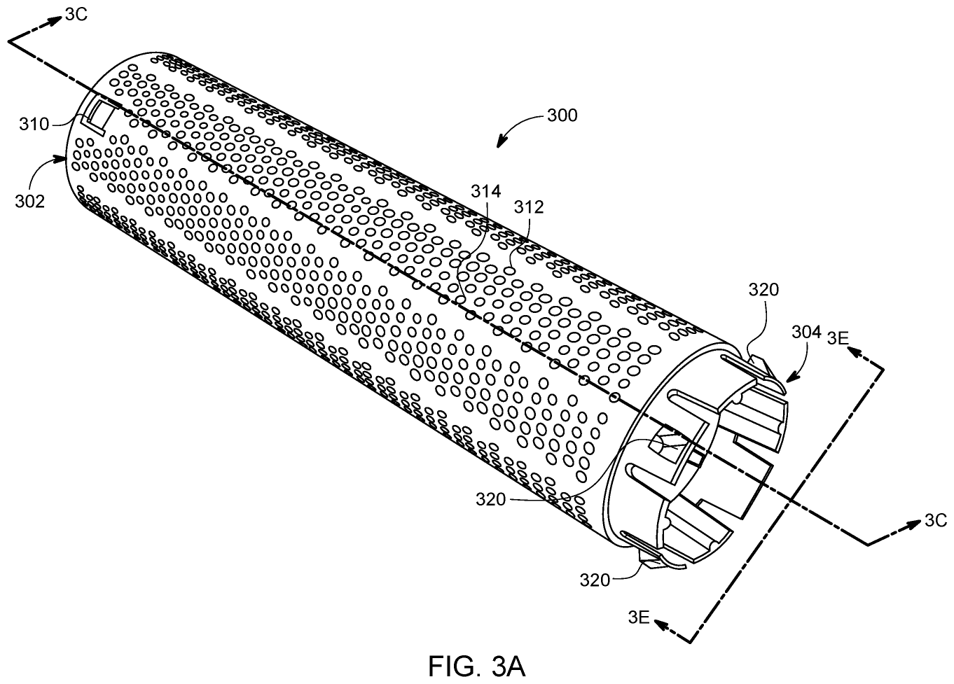

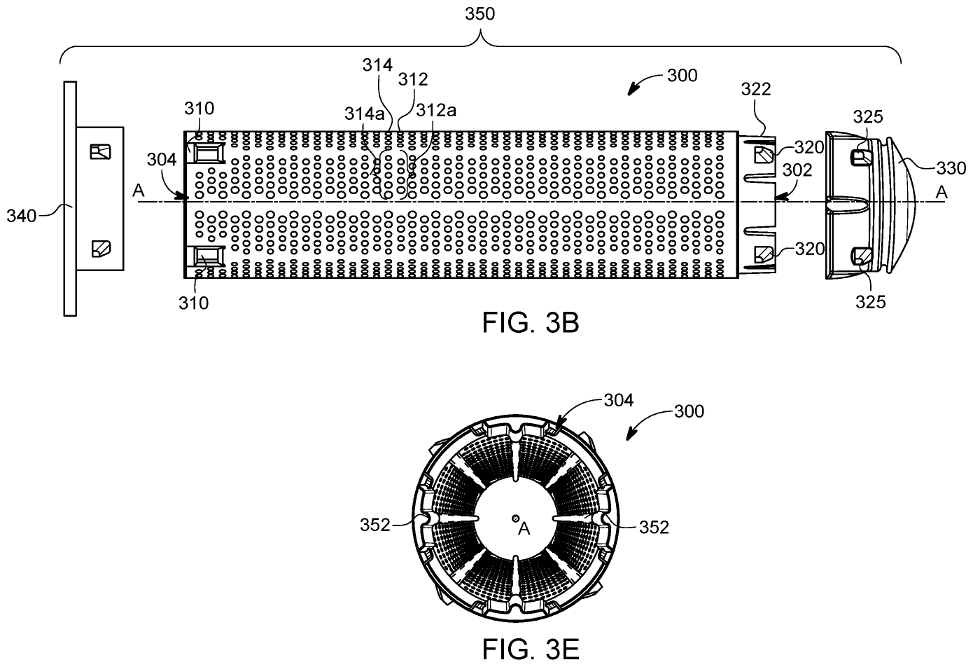

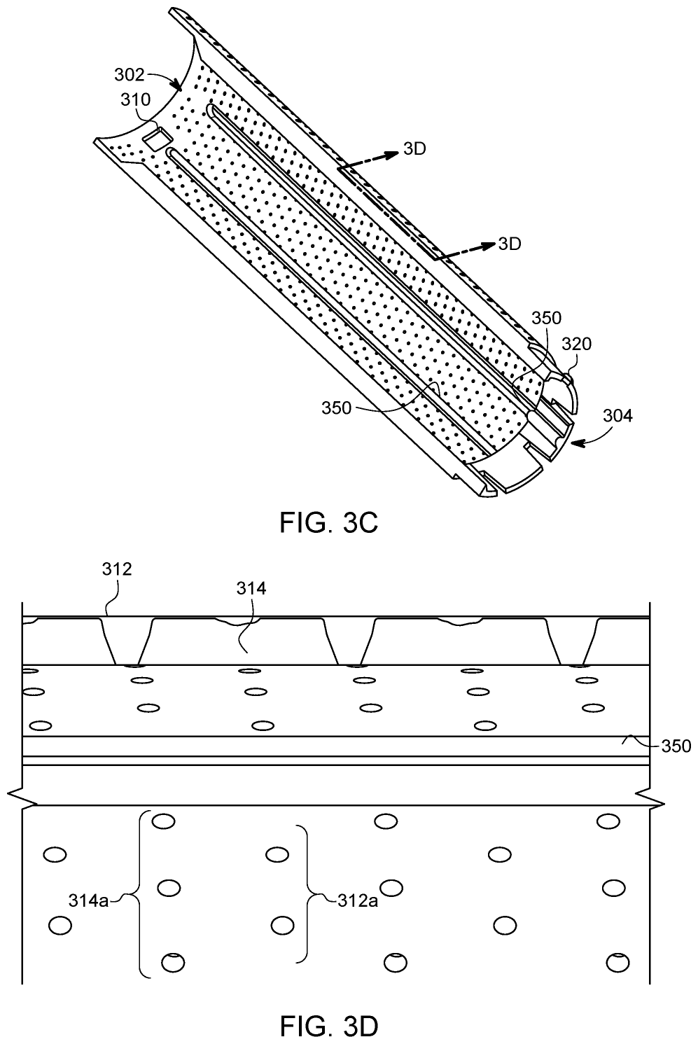

FIGS. 3A-3D show a first embodiment of a modular adhesive anchor screen 300 in accordance with the present technology. As illustrated in FIG. 3B, an adhesive anchor screen 300 comprises a portion of an insert 350 which includes the screen 300, end cap 330 and abutment structure 340. The screen 300 includes a first set of connection structures comprising notches 310 which mate with posts 311 on abutment structure 340 to secure the abutment structure 340 within the interior of screen 300. Screen 300 includes a second set of connection structures comprising posts 320 which mate with notches 325 on end cap 330 to secure end cap 330 on collar 322 of screen 300. The notched 310 can be used to connect with posts 320 to connect multiple screens 300 in series to form varied sizes of inserts.

The adhesive anchor screen 300 is a modular, injection molded plastic adhesive screen designed to work with multiple types of adhesives. The screen 300 includes a variable sized mesh of apertures 312, 314. (In FIG. 3, not every aperture or row of apertures is labeled in order to not obscure the illustration of the screen.) In one embodiment, the apertures are circular and have varying dimensions. For example, a row 314a of apertures 314 may have a diameter of 0.015 inch and a row 312a of apertures 312 may have a diameter of 0.010 inch. In one embodiment, the diameters of each row 312a, 314b of apertures alternates diameters relative to an adjacent row, and repeats over the surface of the screen. In alternative embodiments, different sized apertures are located in the same row in any number of different patterns (i.e., each row need not all be the same sized aperture.) In alternative embodiments, more than two different diameter apertures are used. Each aperture may have a different cross-sectional opening shape. For example, the apertures may be round, rectangular, triangular, oblong, star-shaped, or other geometric shapes. Further, the spacing and pattern of apertures may vary.

As illustrated in FIG. 3C, screen 300 has a generally circular cross-section. The interior of screen 300 includes supporting ribs 352 between a leading or first end 302 which inserted first into a bore and a second, trailing or anchor receiving end 304. In one embodiment, eight supporting ribs are provided on the interior of screen 300. More or fewer ribs may be used.

To make the connection using an anchor, an adhesive 3 is disposed within the interior area of the screen 300 with the with abutment structure 340 and end cap 330 attached after the insert 350 is provided in a substrate. Insertion of an anchor 2 into the insert 350 (screen 300 with abutment structure 340 (or second end cap) and first end cap 330 attached) before the adhesive has set will force the adhesive out of the screen 300 through the apertures 312, 314. Sufficient adhesive is provided into the insert so that the adhesive completely surrounds and is in complete contact with the portion of the anchor 2 inserted into the screen 300. Adhesive is extruded out of the screen 300 and into contact with a bore in the substrate 1 and the anchor 2, through contact with the adhesive, becomes bonded to the substrate when the adhesive sets.

The varying opening size, aperture spacing, and aperture mesh pattern allows the screen 300 to be used with adhesives with different viscosities and/or particle size to work in the same screen. Further variations are possible by vary shape of apertures (round, rectangular, triangular, oblong, star, etc.) and with spacing/pattern.

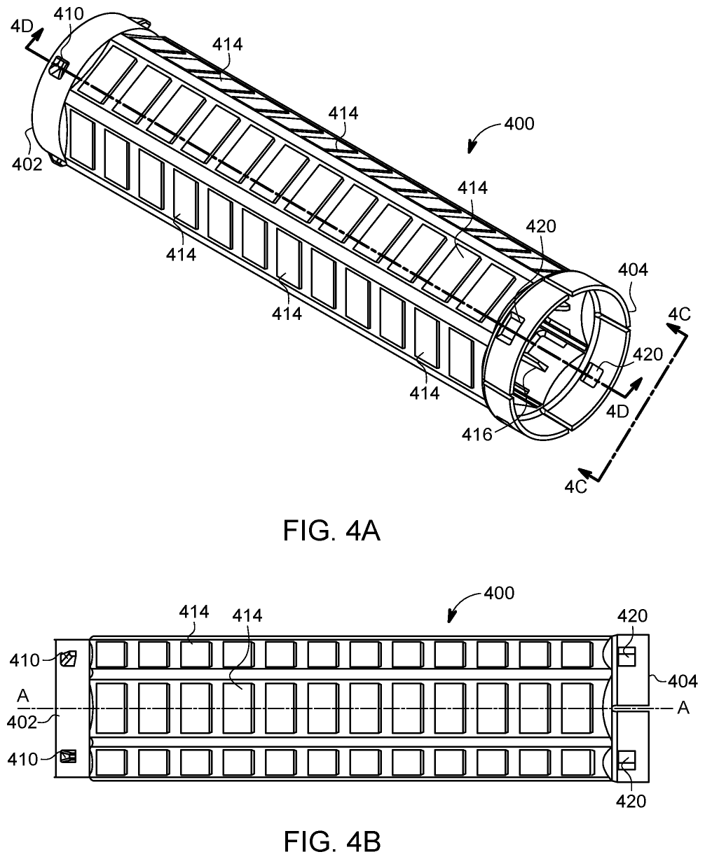

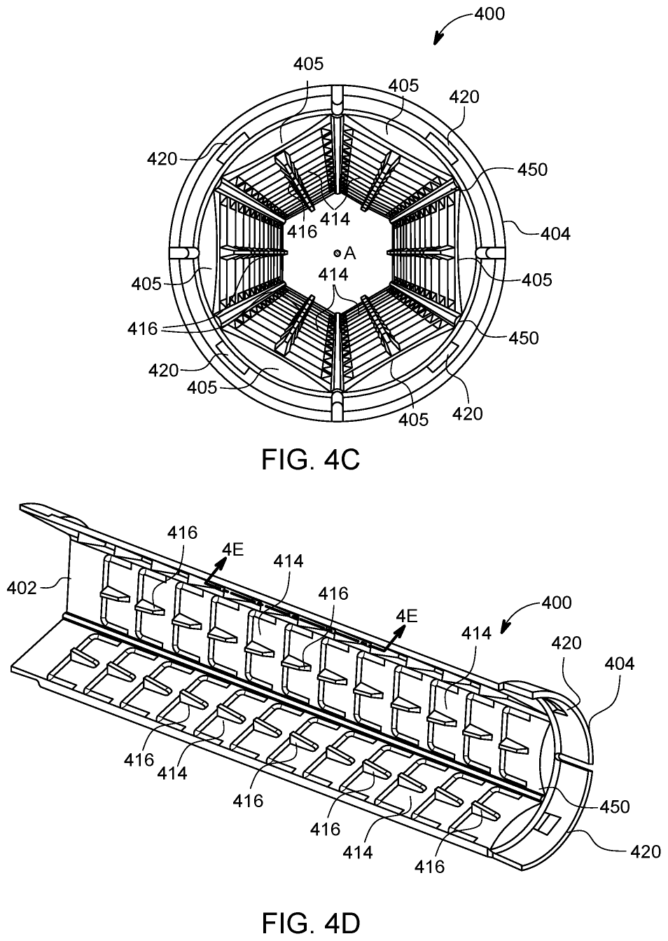

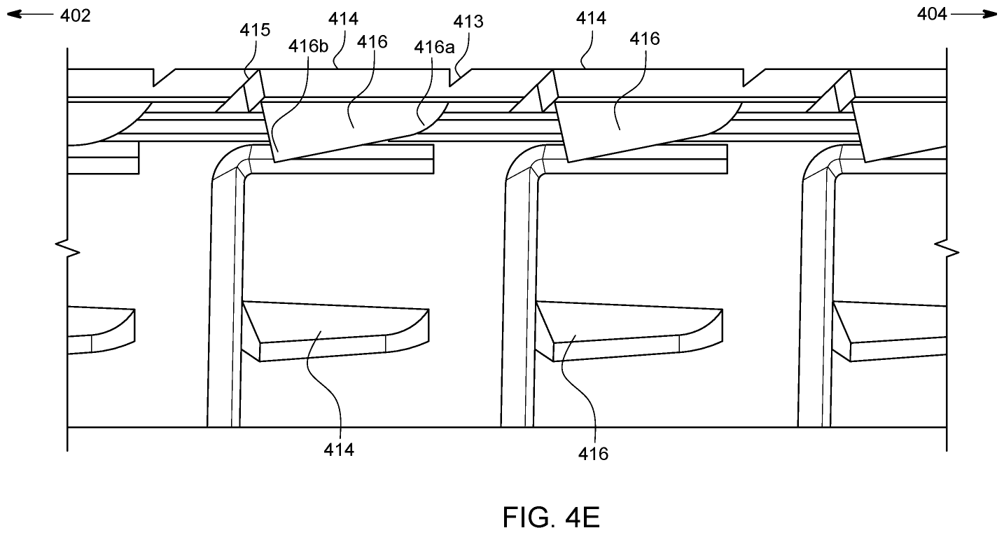

FIGS. 4A-4E show a second embodiment of a screen 400 for use in a modular adhesive insert. Screen 400 includes a plurality of internally activated axial shutters 414 which allow extrusion of adhesive as an anchor forces the shutters open during installation. (The shutters are referred to as “axial” in that they actuate outwardly along the axis (A) of the anchor inserted into the screen 400.) It should be understood that screen 400 may also be fitted with an end cap 330 at a first end 402 and abutment structure 340 at a second end 404 in a manner similar to that shown with respect to screen 300 in FIG. 3B. First end 402 includes a first set of connection structures comprising posts 410 to allow attachment of the end cap and a second set of a first set of connection structures comprising notches 420 in second end 404 which allows connection of an abutment structure and/or allows multiple screens 400 to be connected to each other, thereby allowing multiple sizes of screens to be used to create different sized inserts.

As illustrated in FIGS. 4C-4E, each individual shutter 414 includes an angled cam or cam 416, with the cam 416 including a lower end 416a closer to the second, trailing end 404 of screen 400, and a higher end 416b closer to the leading, first end. As best illustrated in FIG. 4E, each shutter has a free end 415 and a hinged edge 413 connected to a main body for 14. The angled cam 416 forces the shutter 414 open when an anchor is inserted into the interior of screen 400.

As illustrated in FIGS. 4A and 4C, screen 400 has a generally hexagonal cross-section defined by six sides 405, each including axial shutters 414. More or fewer sides may be used in various embodiments. The sides of shutters are separated by supporting ribs 450 between a leading or first end 402 which inserted first into a bore and a second, trailing, anchor receiving end 404. In one embodiment, six supporting ribs are provided but more or fewer ribs, and more or fewer sides having axial shutters, may be used. In other embodiments, some sides need not include shutters and may be interleaved with sides containing shutters.

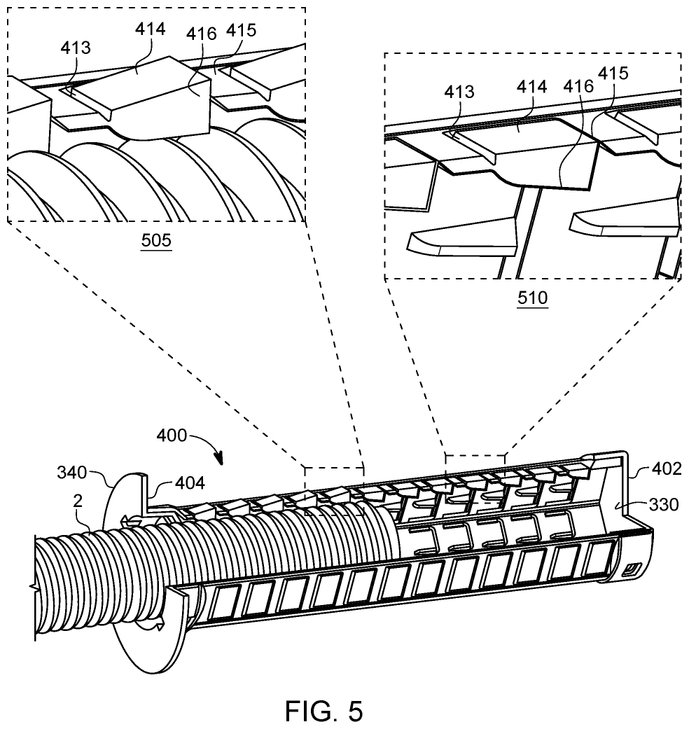

FIG. 5 illustrates an anchor 2 being inserted into screen 400 in the absence of adhesive. (Note that an adhesive would be present during installation of the anchor.) Each angled cam 416 engages the body of the anchor (which in the case of FIG. 5 is a fastener thread). When the anchor engages a cam 416 of a shutter 414, the shutter rotates about hinged edge 413 and its free end 415 is forced outward, allowing any adhesive in the screen to be extruded from the screen and into the substrate (or free space) in which the anchor is being installed, as shown at 505. Shutters which have not been engaged remain closed and prevent extrusion of adhesive at portions of the screen where the anchor has not reached, as shown in FIG. 5 at 510.

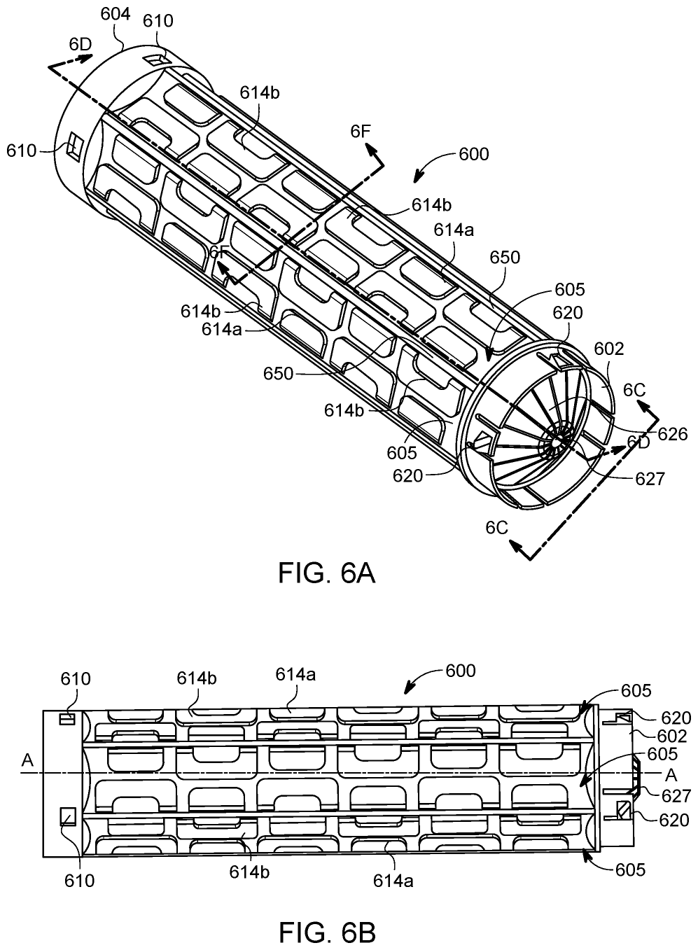

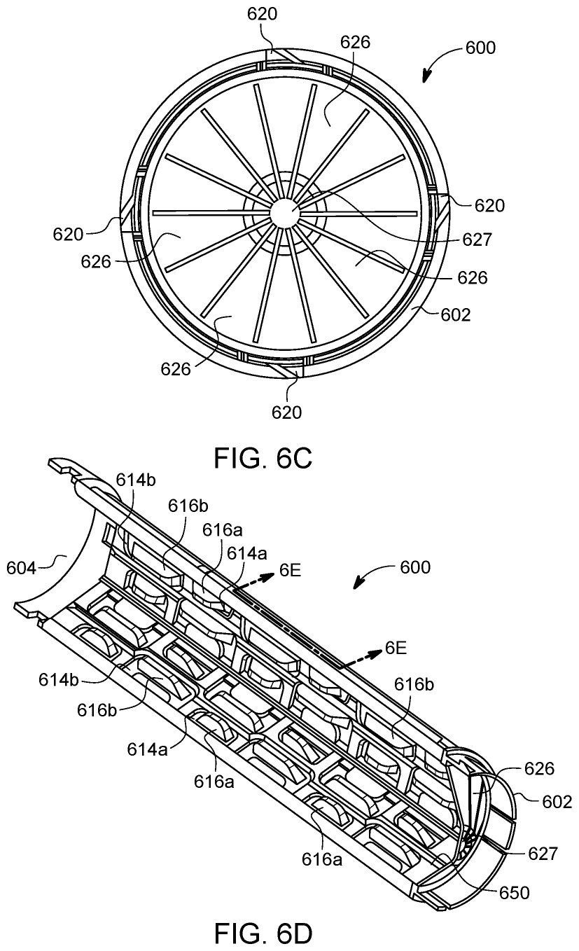

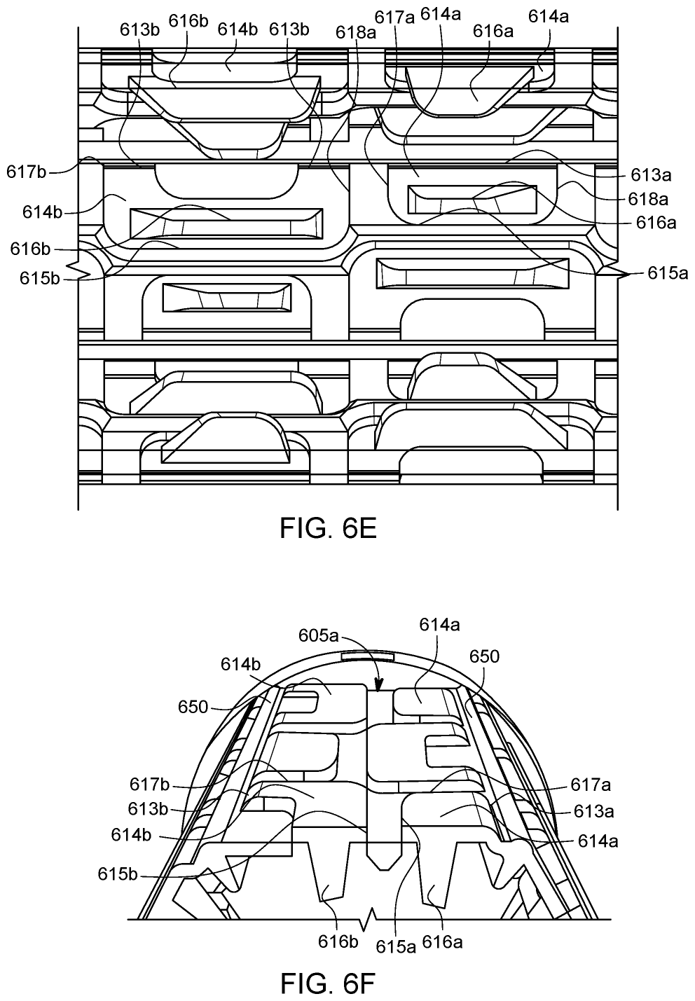

FIGS. 6A-6F illustrates another embodiment of a screen 600 which can be used with a modular adhesive anchor. Screen 600 is formed with a plurality of internally actuated radial shutters 614a and 614b. (The shutters are referred to as “radial” in that they actuate outwardly perpendicular to the axis of the anchor inserted into the screen 600 and along an outer radius of the screen 600.) The shutters are generally planar and arranged into six sides 605. More or fewer sides of shutters may be used. Each side is separated by a support rib 650. Once again, all of the instances of shutters 614 are not numbered in order to not obscure the illustration in the figures. FIG. 6A is a perspective view and FIG. 6B is a plan view of this embodiment. It should be understood that screen 600 may also be fitted with an end cap 330 at a first end 602 and abutment structure 340 at a second end 604 in a manner similar to that shown with respect to screen 300 in FIG. 3B. End 602 includes a first set of connection structures comprising posts 620 to allow attachment of the end cap and a second set of connection structures comprising notches 610 in second end 604 which allows connection of an abutment structure and/or allows multiple screens 600 to be connected to each other.

As shown in FIGS. 6A-6E, the shutters 614a and 614b are of two different sizes and configurations. In alternative configurations, the shutters are the same size and configuration. Shutters 614a are generally smaller than shutters 614b. Each of shutters 614a is placed opposite a corresponding shutter 614b on one side of a screen 600 and alternate along an axial row of one side of the screen 600 so as to be arranged in an interleaved fashion on each side of screen 600. Screen 600 includes six sides, but more or fewer sides may be used. As shown in FIGS. 6E and 6F, each shutter includes a hinge side and three free sides. Shutter 614a includes a single hinge 613a opposite a free end 615a with two free sides 617a and 618a. Shutter 614b includes two hinges 613b opposite a free end 615b with two free sides 617a and 618a. Each shutter 614a and 614b rotates around its hinge or hinges as an anchor enters the interior of the screen and engages angled cams 616a, 616b on respective shutters 614a, 614b. This allows adhesive in the interior of the screen to exit the opening formed by movement of the hinge and be extruded out of the screen into the substrate in which the anchor is being placed.

As shown in FIGS. 6C and 6D, first end 602 includes a web 625 formed by a plurality of generally triangular fingers 626 at the end of which is formed an opening 627. This allows multiple screens to be connected when an anchor is to be provided through multiple cinderblocks, for example. As in previous embodiments, the shutters open to allow adhesive to flow as the anchor is inserted, and closed shutters allow less adhesive (or none) to flow. In addition, the shutters prevent excess adhesive from prematurely flowing out the far end of the screen where the pressure is the highest until the rod is inserted to that depth. Internal shutter cams can be the same height/geometry or different over the length of the screen. This allows adhesives with different viscosities and/or particle size to work in the same screen and controls adhesive flow throughout the entire length of the screen.

Screen 600 has a generally hexagonal cross-section defined by six sides, each including radial shutters 614a, 614b. The sides of shutters are separated by supporting ribs 650 between a leading, distal end 602 which inserted first into a bore and a trailing or anchor receiving end 604. In one embodiment, six supporting ribs are provided but more or fewer ribs, and more or fewer sides having radial shutters, may be used. In other embodiments, some sides need not include radial shutters and may be interleaved with sides containing radial shutters.

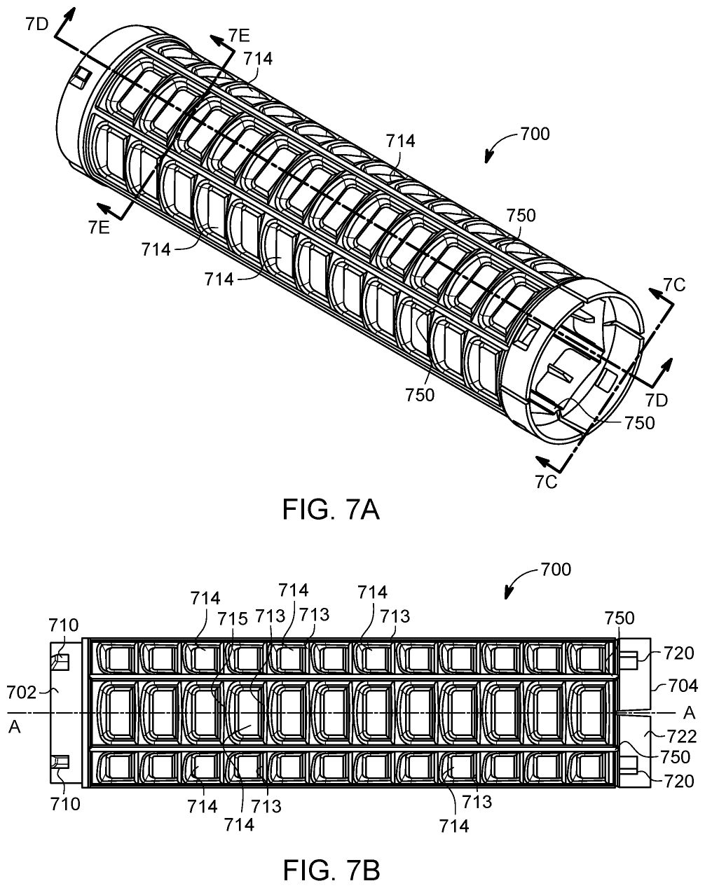

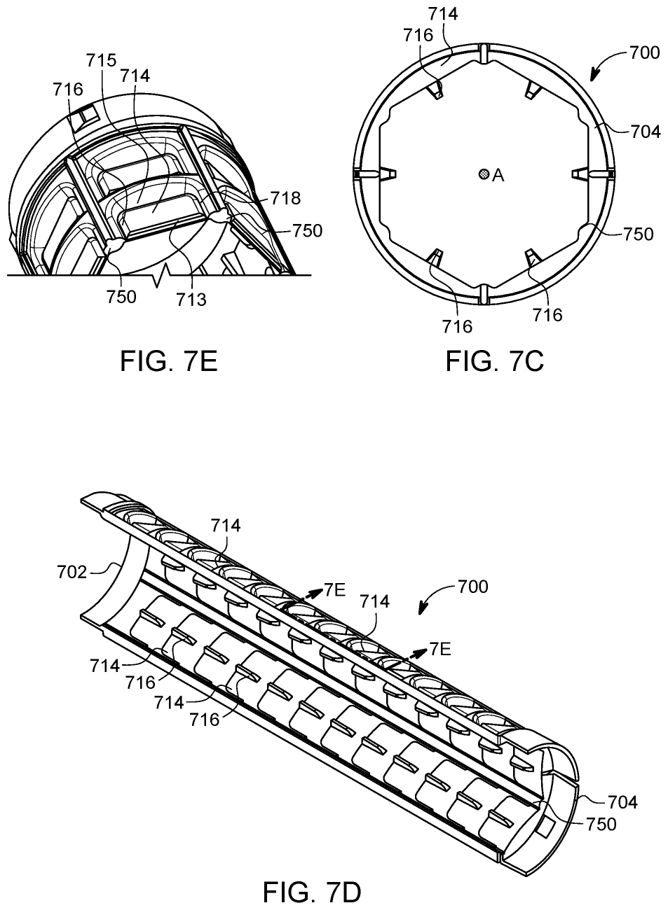

FIGS. 7A-7F illustrate another embodiment of a screen 700 which can be used with a modular adhesive anchor insert. FIG. 7A is a perspective view and FIG. 7B is a plan view of this embodiment. Screen 700 is formed with a plurality of internally actuated axial shutters 714 arranged in six rows on screen 700, each row separated by a support rib 750. All of the instances of the shutters are not numbered in order to not obscure the illustration in the figures. It should be understood that screen 700 may also be fitted with an end cap 330 at a first end 702 and abutment structure 340 at a second end 704 in a manner similar to that shown with respect to screen 300 in FIG. 3B. In addition, end 702 may engage end 704 to connect multiple ones of screens together. The screen 700 includes a first set of connection structures comprising posts 710 on end 702 to mate with an end cap 330, and a second set of connection structures comprising notches 720 end 704 to mate with posts 710 abutment structure 340.

As shown in FIGS. 7B-7E, the shutters 714 are generally equally sized and each shutter includes a hinge side and three free sides. Shutter 714 includes a single hinge 713 opposite a free end 715 with two free sides 717 and 718. Each shutter 714 rotates around its hinge as an anchor enters the interior of the screen and engages angled cams 716 on a respective hinge 713. This allows adhesive in the interior of the screen to exit the opening formed by movement of the hinge and be extruded out of the screen into the substrate in which the anchor is being placed.

Screen 700 has a generally hexagonal cross-section defined by six sides, each including radial shutters 714. The sides of shutters are separated by supporting ribs 750 between a leading, distal end 702 which is inserted first into a bore and a trailing or anchor receiving end 704. In one embodiment, six supporting ribs are provided but more or fewer ribs, and more or fewer sides having radial shutters, may be used. In other embodiments, some sides need not include radial shutters and may be interleaved with sides containing radial shutters.

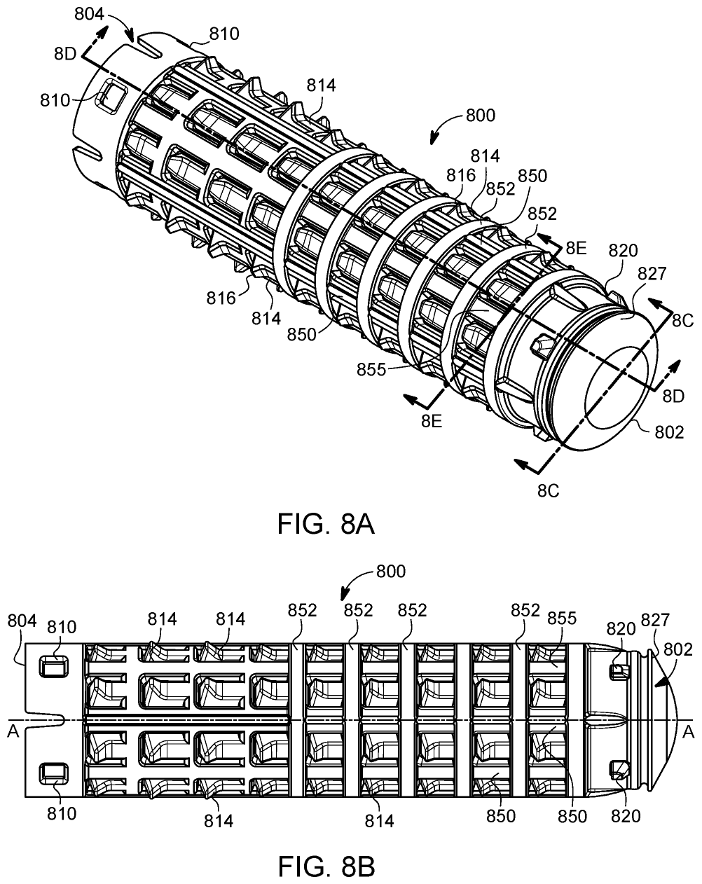

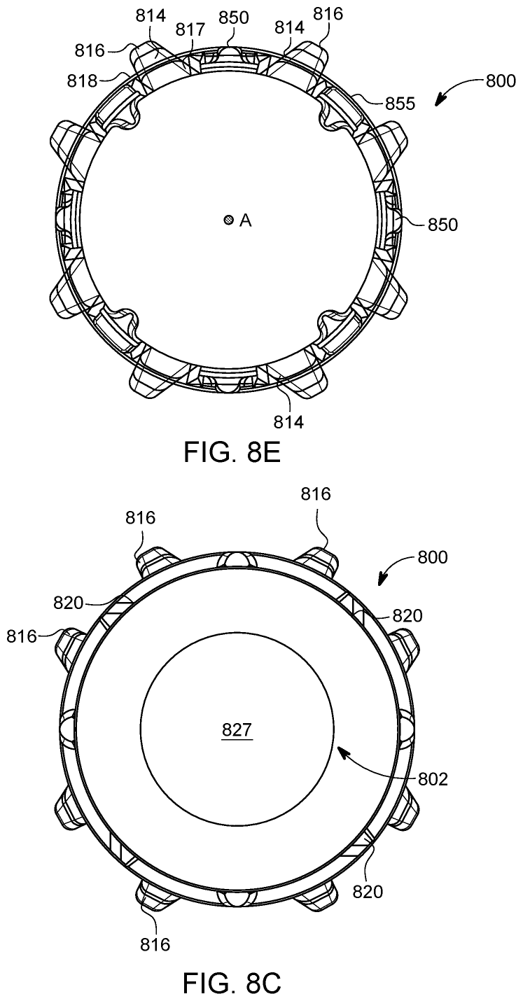

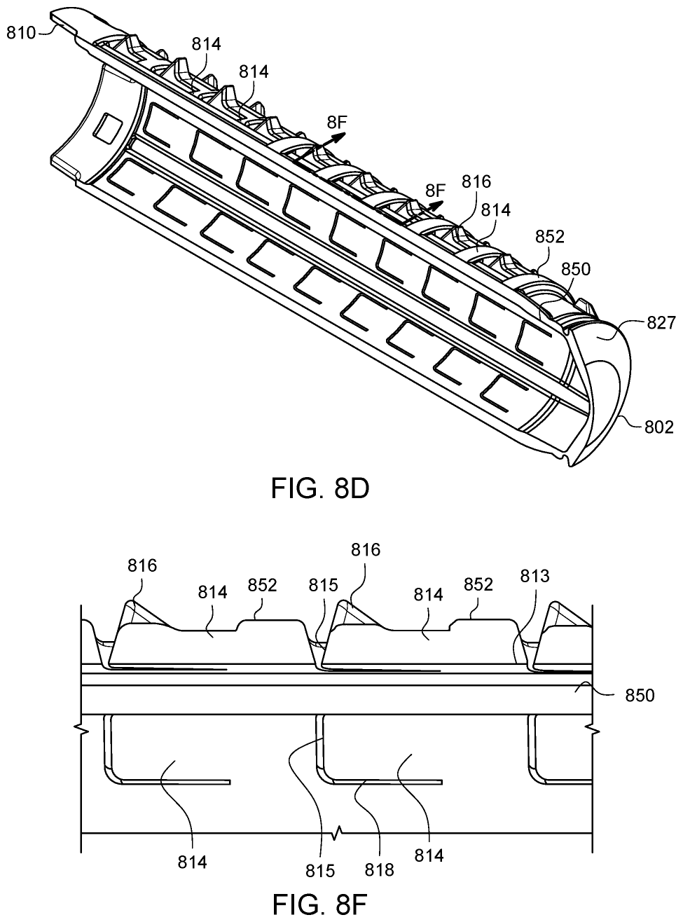

FIGS. 8A-8F illustrate another embodiment of a screen 800 which can be used with an adhesive anchor insert. FIG. 8A is a perspective view and FIG. 8B is a plan view of this embodiment. Screen 800 is formed with a plurality of externally actuated axial shutters 814 arranged in eight rows on screen 800. All of the instances of the shutters are not numbered in order to not obscure the illustration in the figures. An end cap 827 is illustrated as attached to a first leading end 802 of screen 800. Screen 800 may also be fitted with an abutment structure at a second end 804 in a manner similar to that shown with respect to screen 300 in FIG. 3B. The screen 800 includes connection structures comprising 820 on end 802 and connection structures comprising notches 810 end 804 to mate with posts 820 or, as shown, corresponding notches on an end cap 827 of screen 800. In some implementations, end 802 may engage end 804 to connect multiple ones of screens together using notches 810 and posts 820.

As shown in FIGS. 8B-8E, the shutters 814 are generally equally sized and each shutter includes a cam 816, hinge side 813 and three free sides 815, 817, and 818. Shutter 814 includes a single hinge side 813 opposite a free end 815 with two free sides 818 and 818, thereby defining each shutter as having a generally rectangular shape in the axial direction of the screen 800. Each shutter 814 rotates around its hinge as the screen enters bores formed in the substrate or substrate walls to which the screen is inserted. As such, an adhesive within the screen during installation only is extruded in areas adjacent to open regions in the substrate.

Eight shutters 814 are provided about a circular cross section (FIG. 8E), forming a ring of shutters about the cross-section. Each of the eight shutters aligned in one of the five rings of shutters near the first end 802 about the screen 800 is separated by a support ring 852 along approximately half of the screen 800 adjacent to the first end 802. In embodiments, the first five rings of shutters are separated by a support ring 852, while the last four rings of shutters are not separated by a support ring. Each shutter in a ring of shutters is separated by either a supporting rib 850 or a supporting rib 855 between a leading, distal end 804 which inserted first into a bore and a trailing or anchor receiving end 804. In one embodiment, eight supporting ribs 850, 855 (four each) are provided but more or fewer ribs, and more or fewer shutters in each ring, may be used. In other embodiments, some sides need not include shutters and may be interleaved with sides containing shutters.

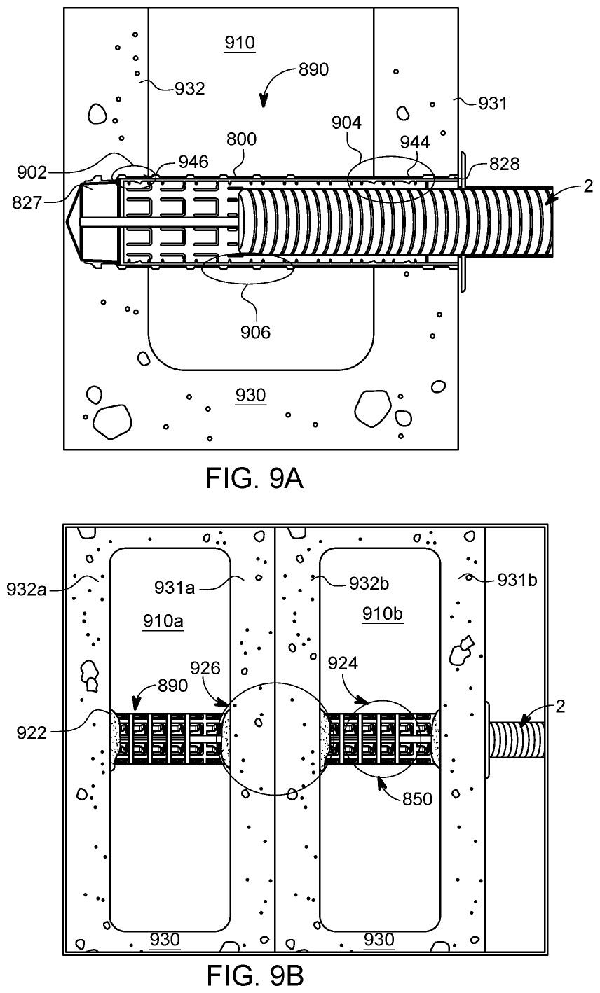

FIGS. 9A and 9B illustrate the opening of the shutters and extrusion of adhesive. FIG. 9A illustrates an assembled insert 890 including screen 800 with end cap 827 and abutment structure 828 attached. The insert 890 has been inserted into a first bore 944 formed in a first web 931 of a hollow substrate 930, extends across an interior cavity 910 of the hollow substrate 930, and is received in second aperture formed in the second opposite web 932 of the substrate 930. As illustrated in FIG. 9A, at 902, 904, shutters 814 within bores 944 and 945 are open, with cams 816 of any shutters within the bores engaging the sides of bores 944, 945 forcing rotation of each shutter about its hinge side 813 toward the interior of screen 900. This allows adhesive to extrude out of the open shutters within the solid portion of webs 931 and 932 (in regions 902) to bond with the solid web of the substrate 930, and also extend slightly adjacent to the webs 931, 932 to maximize bonding with the solid material. At 906, shutters within the interior cavity 910 in the substrate are closed, preventing, or inhibiting extrusion of adhesive within most of interior cavity 910. As a result, when anchor 2 is inserted into the screen 800, extrusion occurs adjacent to the respective webs 931, 932 out of the open shutters within the webs 931, 932 at region 902. This is illustrated in FIG. 9B which shows screen 800 and abutment structure 828 attached (and end cap within web 952) As illustrated in FIG. 9B, extrusion of adhesive within cavity 910a, 910b occurs adjacent to the respective webs 931a, 931b, 932a, 932b (e.g., at 922 and 926, for example,) when the anchor 2 is fully inserted into screen 800. Thus, shutters 914 are activated externally to open only in solid portions of base material to allow more adhesive to flow out where the base material is solid and closed shutters located in hollow sections of base material allow less adhesive (or none) to flow.

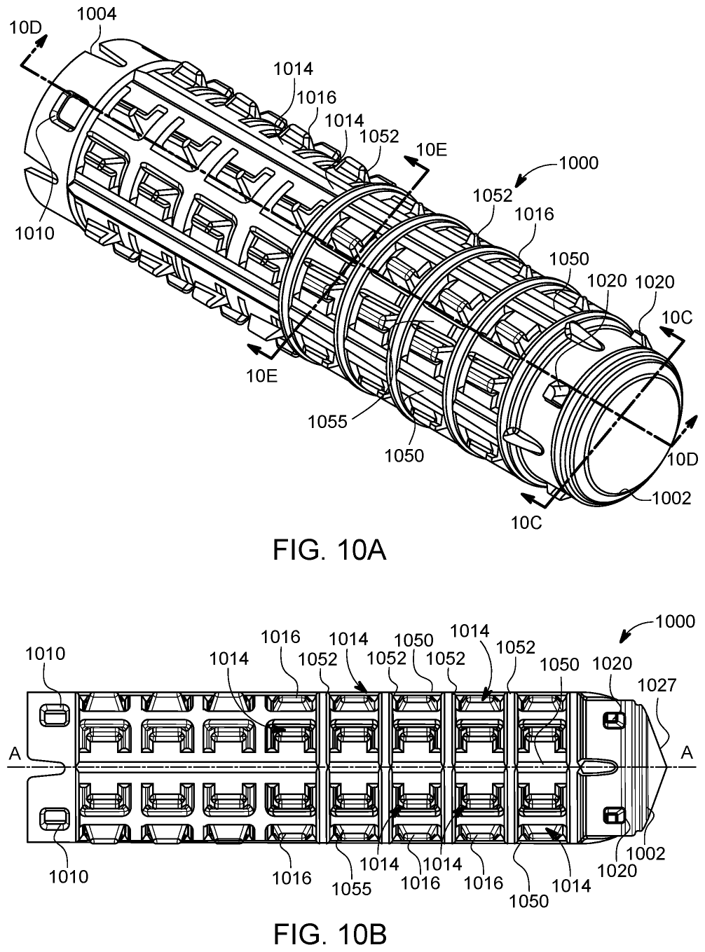

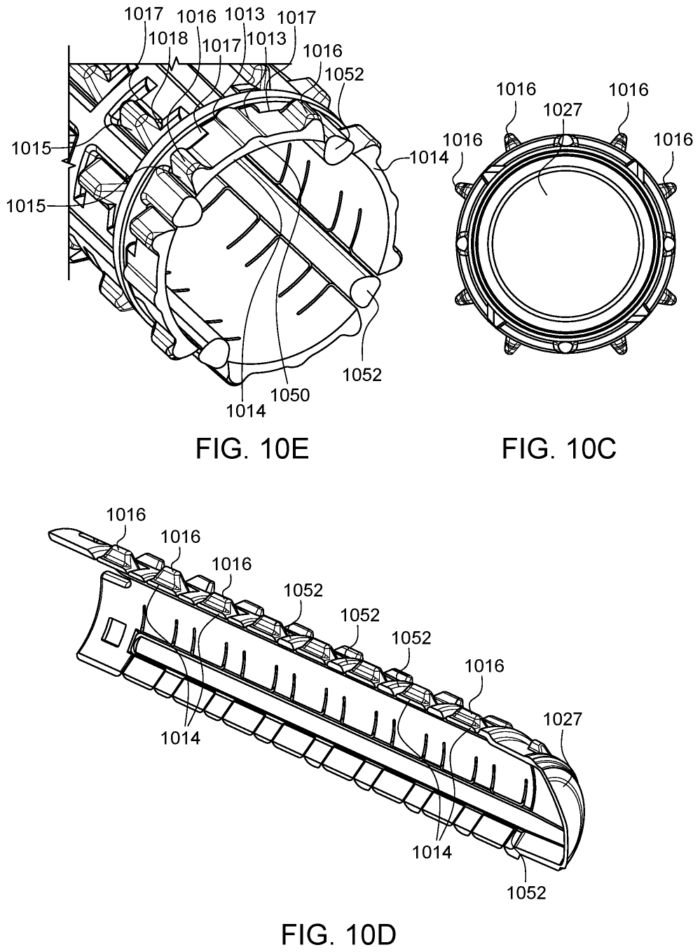

FIGS. 10A-10E illustrate another embodiment of a screen 1000 which can be used with an adhesive anchor insert. FIG. 10A is a perspective view and FIG. 10B is a plan view of this embodiment. Screen 1000 is formed with a plurality of externally actuated radial shutters 1014 arranged in eight rows on screen 1000. All of the instances of the shutters are not numbered in order to not obscure the illustration in the figures. Each of the eight shutters aligned in one of the four rings of shutters near the first end 1002 about the screen 1000 is separated by a support ring 1052 along approximately half of the screen 1000 adjacent to the first end 1002. In embodiments, the first four rings of shutters are separated by a support ring 1052, while the last four rings of shutters are not separated by a support ring. An end cap 1027 is illustrated as attached to a first leading end 1004 of screen 1000. Screen 1000 may also be fitted with an abutment structure at a second end 1002 in a manner similar to that shown with respect to screen 300 in FIG. 3B. The screen 1000 includes connection structures comprising posts 1020 on end 1004 and connection structures comprising notches 1010 end 1002 to mate with posts 1020 or, as shown, corresponding notches on an end cap 1027 of screen 1000. In some implementations, end 1002 may engage end 1004 to connect multiple ones of screens together using notches 1010 and posts 1020.

As shown in FIGS. 10B-10E, the shutters 1014 are generally equally sized and each shutter includes a cam 1016, hinge side 1013 and three free sides 1015, 1017, and 1018. Shutter 1014 includes a single hinge side 1013 opposite a free end 1015 with two free sides 1018 and 1018, thereby defining each shutter as having a generally rectangular shape in the axial direction of the screen 1000. Each shutter 1014 rotates around its hinge as the screen enters bores formed in the substrate or substrate walls to which the screen is inserted. As such, an adhesive within the screen during installation only is extruded in areas adjacent to open regions in the substrate.

Eight shutters 1014 are provided about a circular cross section (FIG. 10E), forming a ring of shutters about the cross-section. Each hinge side 1013 is attached to a support rib 1050. Each free side 1015 opposes one of four internal support boss 1052. Each of the eight shutters aligned in a ring about the screen 1000 is separated by a support ring 1052. Four support rings 1052 are provided between the leading end 1004 and approximately half-way toward the trailing end 1002 of screen 1000. Supporting ribs 1050 and supporting ribs 1052 extend between a leading, distal end 804 which inserted first into a bore and a trailing or anchor receiving end 1002. In one embodiment, eight supporting ribs 1050, 1055 (four each) are provided but more or fewer ribs, and more or fewer shutters in each ring, may be used. In other embodiments, some sides need not include shutters and may be interleaved with sides containing shutters.

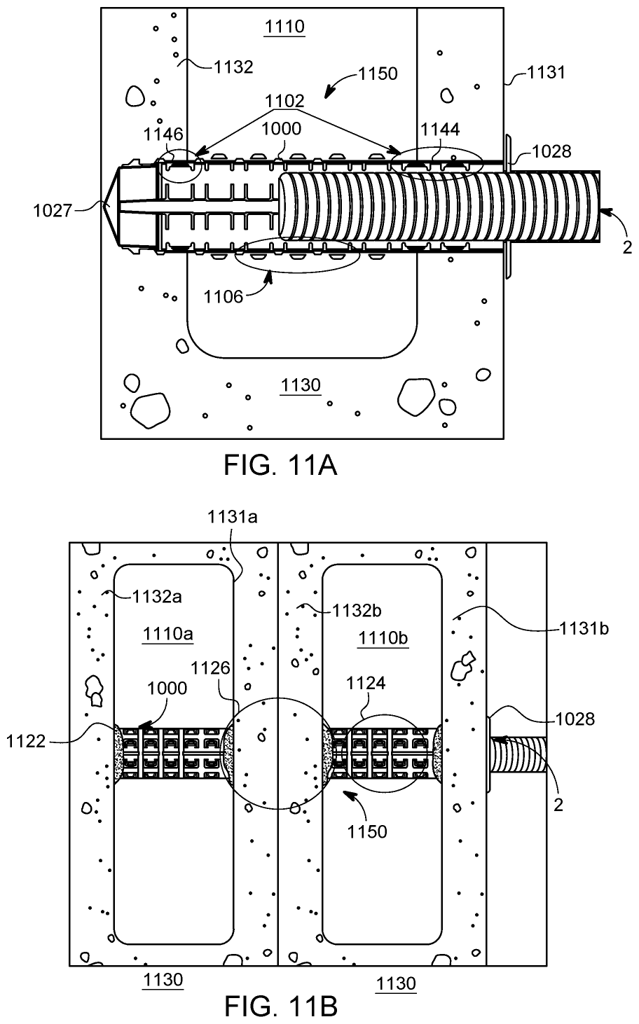

FIGS. 11A and 11B are similar to FIGS. 9A and 9B and illustrate opening of the shutters and extrusion of adhesive using screen 1000 in an insert 1150. FIG. 11A illustrates an insert 1150 with screen 1000, and end cap 1027 and abutment structure 1028 attached. The insert 1050 has been inserted into a first bore 1144 formed in a first web 1131 of a hollow substrate 1130, extends across an interior cavity 1110 of the hollow substrate 1130, and is received in second aperture formed in the second opposite web 1132 of the substrate 1130. As illustrated in FIG. 11A, at 1102, shutters 1014 within bores 1144 and 1145 are open, with cams 1016 of any shutters within the bores engaging the sides 1144, 1145 of bores forcing rotation of each shutter about its hinge side 1013 toward the interior of screen 1100. This allows adhesive to extrude out of the open shutters within the solid portion of webs 1131 and 1132 to bond with the solid web of the substrate 1130, and also extend slightly adjacent to the webs 1131, 1132 to maximize bonding with the solid material. At 1106, shutters within the voids 1110a, 1110b are closed, preventing, or inhibiting extrusion of adhesive within most of the web voids 1110a, 1110b. As a result, when anchor 2 is inserted into the screen 1000, extrusion occurs adjacent to the respective webs 1131, 1132 and in region 1102 as the shutters are open in this region. This is illustrated in FIG. 11B which shows screen 1000 and abutment structure 1028 attached (and end cap within web 1152) As illustrated in FIG. 11B, extrusion of adhesive within cavity 1110a, 1110b occurs adjacent to the respective webs 1131a, 1131b, 1132a, 1132b when the anchor 2 is fully inserted into screen 1000. Thus, shutters 1114 are activated externally to open only in solid portions of base material to allow more adhesive to flow out where the base material is solid and closed shutters located in hollow sections of base material allow less adhesive (or none) to flow. Again, shutters at 1124 are closed so the adhesive is extruded adjacent to the walls of webs 1131, 1132 at 1122 and 1126, for example.

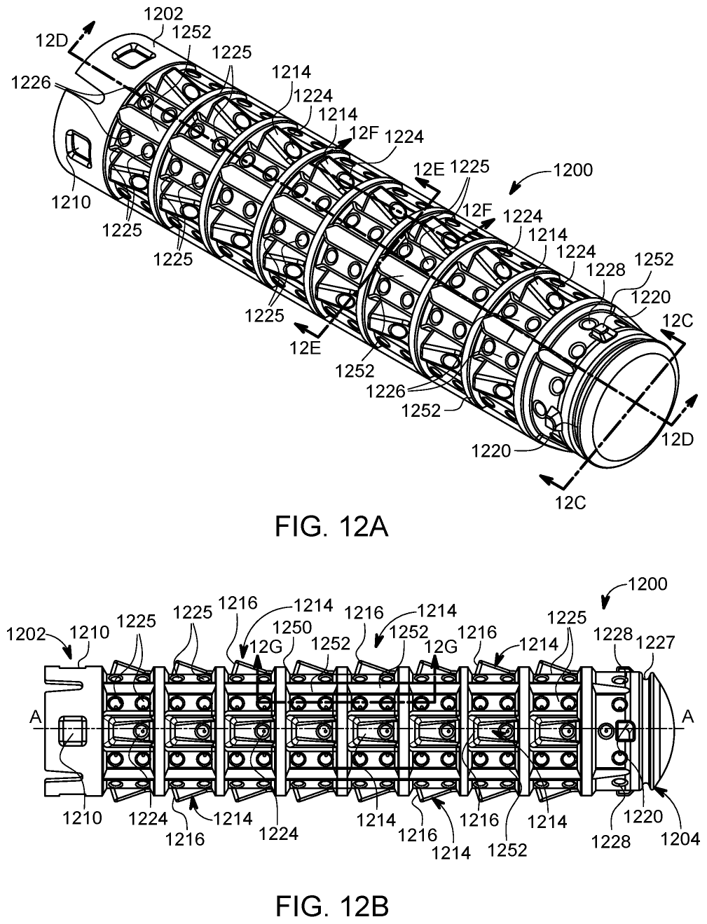

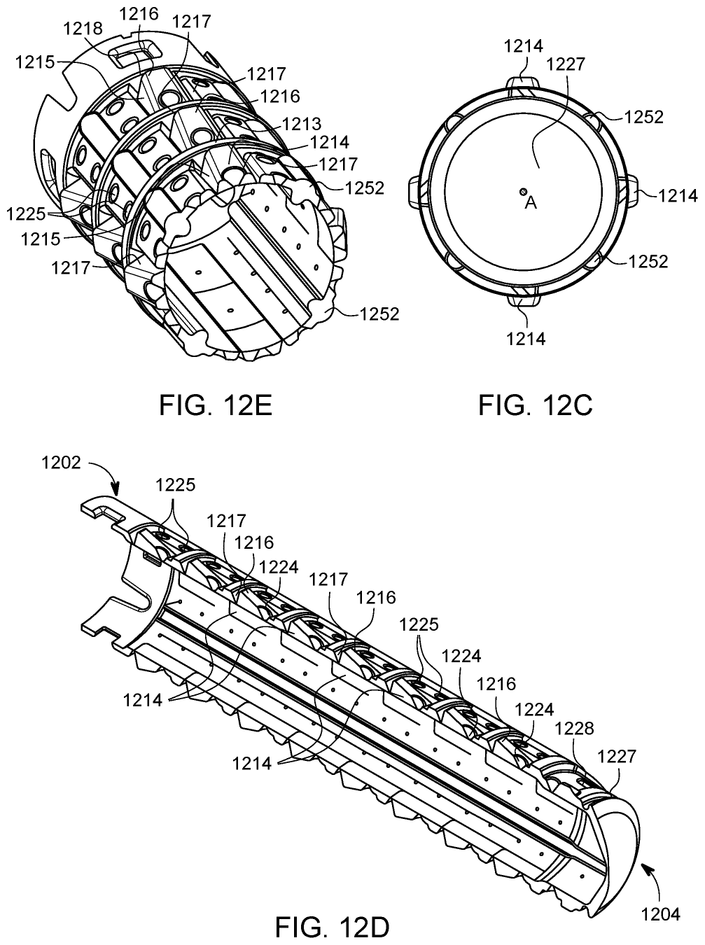

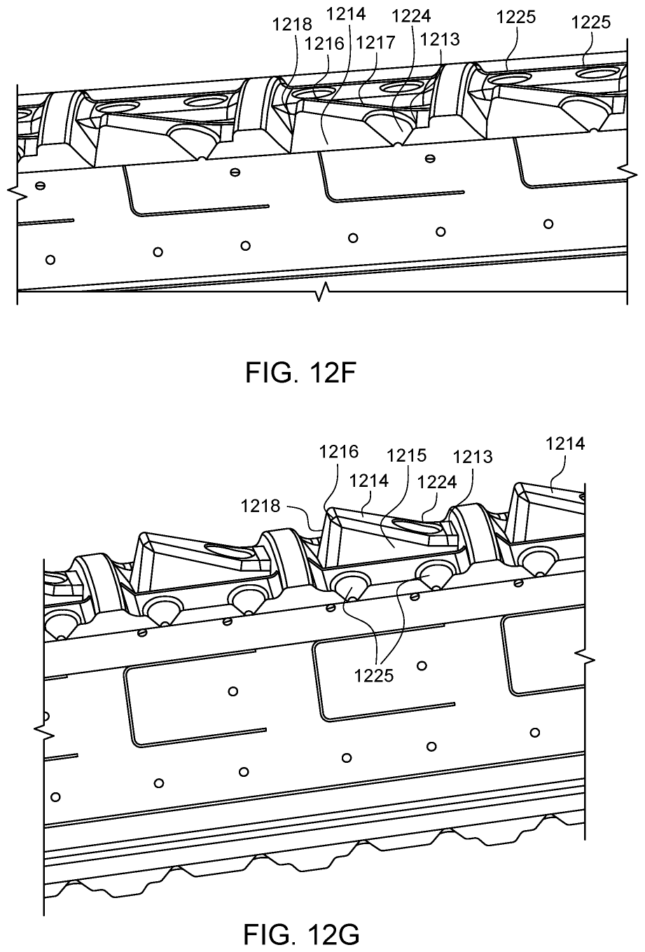

FIGS. 12A-12F illustrate another embodiment of a screen 1200 which can be used with an adhesive anchor insert. FIG. 12A is a perspective view and FIG. 12B is a plan view of this embodiment. Screen 1200 is formed with both a plurality of externally actuated radial shutters 1214 arranged in four rows on screen 1200, and a plurality of apertures 1224, 1225, and 1228. with the apertures provided in both the radial shutters and fixed portions in the screen 1200 such that they are coincident with the shutters. All of the instances of the shutters and apertures are not numbered in order to not obscure the illustration in the figures. Sections of shutters 1214 are separated by support rings 1250. An aperture 1224 is provided in each of the radial shutters 1214. Apertures 1225 are provided in fixed wall panels 1226. Apertures 1228 are provided in end cap 1227. Two panels 1226 are adjacent to each radial shutter 1214, and two panels 1226 are separated by one of four support bosses 1252. An end cap 1227 is illustrated as attached to a first, leading end 1204 of screen 1200. In this embodiment, end cap 1227 is integrally formed with the rest of screen 1200 through a plastic molding process. Screen 1200 may also be fitted with an abutment structure at a second end 1202 in a manner similar to that shown with respect to screen 300 in FIG. 3B. Screen 1200 includes connection structures comprising posts 1220 on end 1204 and connection structures comprising notches 1210 end 1202 to mate with posts 1220 or, as shown, corresponding notches on an end cap 1227 of screen 1200. In some implementations, end 1202 may engage end 1204 to connect multiple ones of screens together using notches 1210 and posts 1220.

As shown in FIGS. 12B-12E, the shutters 1214 are generally equally sized and each shutter includes a cam 1216, hinge side 1213 and three free sides 1215, 1217, and 1218. Shutter 1214 includes a single hinge side 1213 opposite a free end 1215 with two free sides 1218 and 1218, thereby defining each shutter as having a generally rectangular shape in the axial direction of the screen 1200. Each shutter 1214 rotates around its hinge 1213 toward the interior of the screen 1200 as the screen enters bores formed in the substrate or substrate walls to which the screen is inserted. As such, an adhesive within the screen during installation is extruded all along the length of the screen, but more so in areas adjacent to any web walls and within substrate walls due to open shutters.

Four shutters 1214 are provided around a circular cross section (FIG. 12E). Each hinge side 1213 is attached to a support rib 1250. Each free side 1215 opposes one of four internal support boss 1252. Each of the eight shutters aligned in a ring about the screen 1200 is separated by a support ring 1252. Four support rings 1252 are provided between the leading end 1204 and approximately half-way toward the trailing end 1202 of screen 1200. Supporting ribs 1250 and supporting ribs 1252 extend between a leading, distal end 804 which inserted first into a bore and a trailing or anchor receiving end 1202. In one embodiment, eight supporting ribs 1250, 1255 (four each) are provided but more or fewer ribs, and more or fewer shutters in each ring, may be used. In other embodiments, some sides need not include shutters and may be interleaved with sides containing shutters.

As noted above, the embodiment of FIGS. 12A-12F includes the axial shutters as well as fixed apertures coincident with the apertures. This embodiment provides an advantage as being adaptable for different drilling techniques in the field which might lead to slightly different diameters of a drilled hole in the substrate. Different diameter holes in the substrate will affect how much the shutters can open, and in the case of an extremely oversized hole, the shutters might not open much at all resulting in very little adhesive extruding out of the screen. The addition of the fixed holes allows for some amount of adhesive to come out over the entire length of the screen even if the shutters are not completely opened by the substrate. In this instance, some smaller amount of adhesive can come out the holes over the entire length of the screen and then additional adhesive will come out in the solid parts of the substrate where the shutters are forced open, creating a strong bond in those areas.

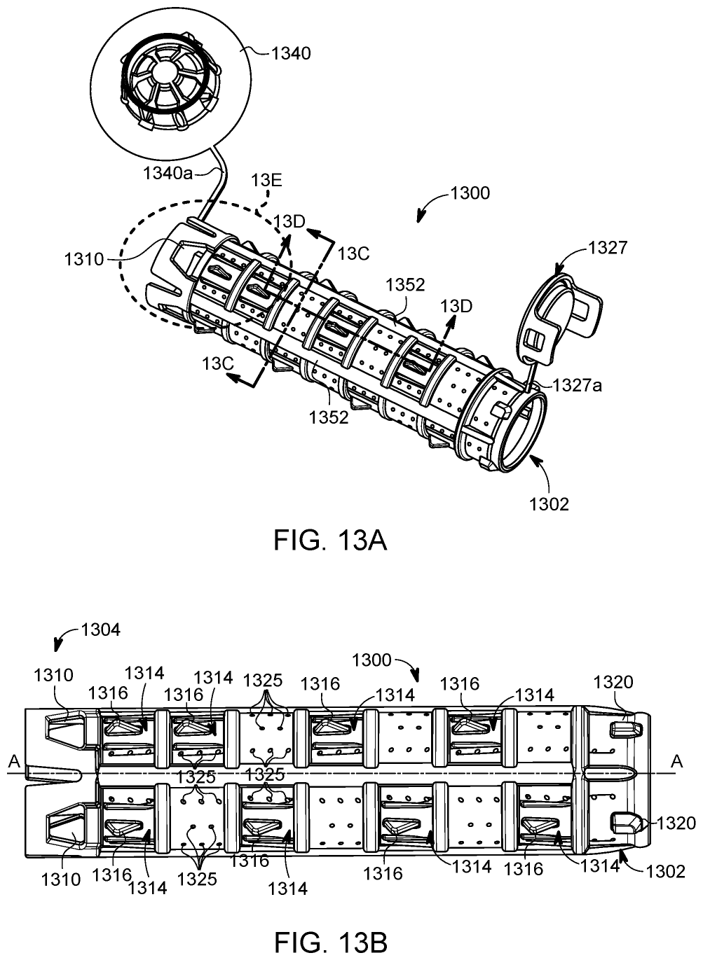

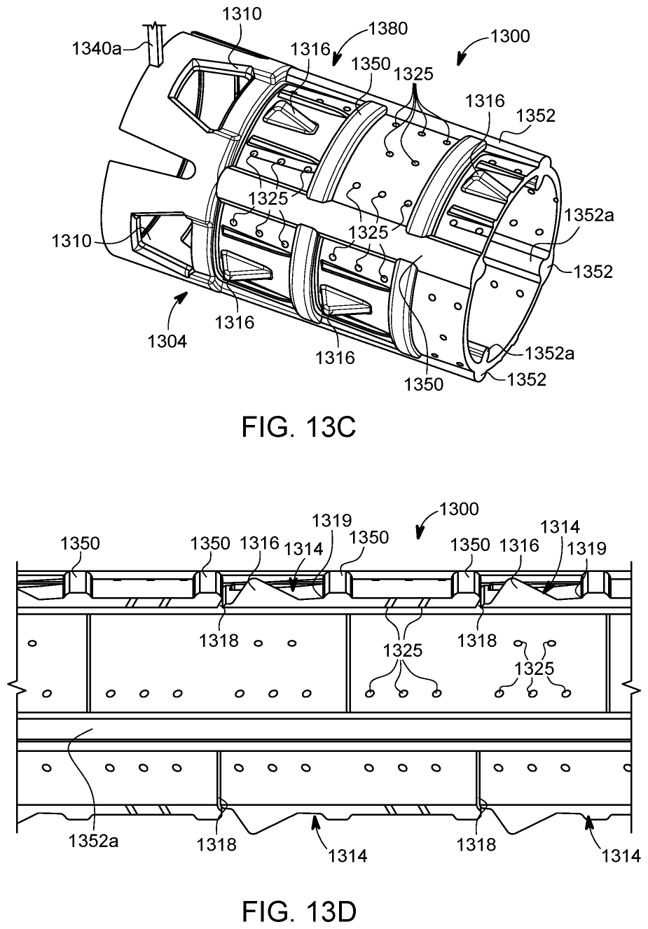

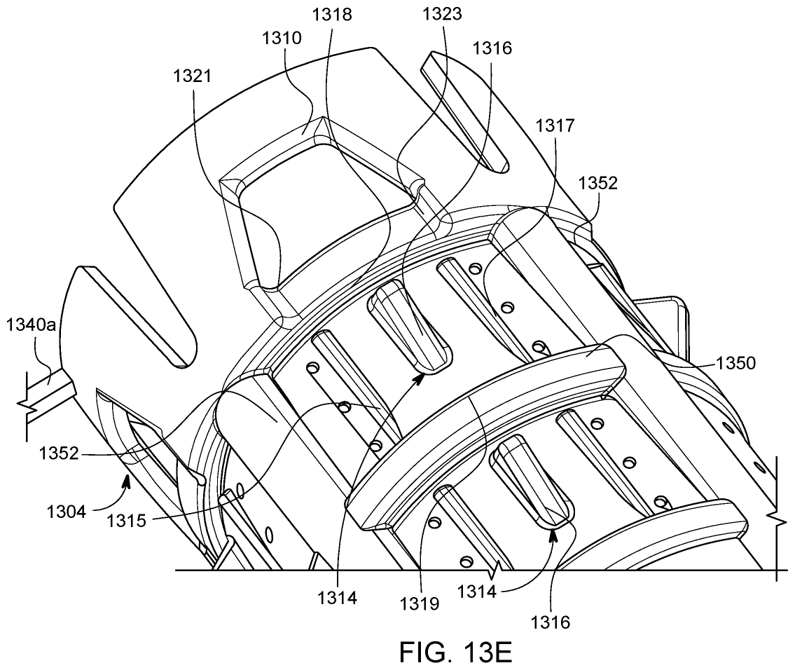

FIGS. 13A-13E illustrate another embodiment of a screen 1300 which can be used with an adhesive anchor insert. FIG. 13A is a perspective view and FIG. 13B is a plan view of this embodiment. FIG. 13C is a view along line 13C-13C of FIG. 13A. FIG. 13D is a view along line 13D-13D of FIG. 13A. FIG. 13E is an enlarged view of the end portion illustrated in FIG. 13A.

Screen 1300 is formed with a plurality of externally actuated shutters 1314 which have a limited range with only one open side 1318 (shown in FIG. 3D). The shutters 1314 are arranged in four rows on screen 1300, with a plurality of apertures 1325 provided in fixed portions in the screen 1300. All of the instances of the shutters and apertures are not numbered in order to not obscure the illustration in the figures. Radial sections of shutters 1314 are separated by support rings 1350. Seven support rings 1350 are provided in one embodiment. In each radial section except section 1380 nearest end 1304, two opposing shutters are provided. In radial section 1380 near end 1304, four shutters 1314 are provided. Apertures 1325 are provided in fixed wall panels 1326. One of four support bosses 1352 separate each of shutters 1314 and fixed wall panels 1326. An end cap 1327 is illustrated as attached to a first, leading end 1304 of screen 1300. In this embodiment, end cap 1327 is integrally formed with the rest of screen 1300 through a plastic molding process but attached to the screen by tab 1327a. Screen 1300 may also be fitted with an abutment structure 1340 at a second end 1302 in a manner similar to that shown with respect to screen 300 in FIG. 3B. Abutment structure 1340 is also integrally formed and attached to screen 1300 by tab 1340a. The screen 1300 includes connection structures comprising posts 1320 on end 1302 and connection structures comprising notches 1310 at end 1304 to mate with posts 1320 or, as shown, corresponding notches on an end cap 1327 of screen 1300. In some implementations, end 1302 may engage end 1304 to connect multiple ones of screens together using notches 1310 and posts 1320.

As shown in FIGS. 13B-13E, the shutters 1314 are generally equally sized and as shown particularly in FIG. 3E, each shutter includes a cam 1316, an open side 1318 and two indented sides 1315 and 1317. A fourth side 1319 is connected to one of rings 1350, thereby defining each shutter as having a generally rectangular shape in the axial direction of the screen 1300. Each shutter 1314 may be depressed inwardly to increase the area at side toward the interior of the screen 1300 as the screen enters bores formed in the substrate or substrate walls to which the screen is inserted. As such, an adhesive within the screen during installation is extruded all along the length of the screen, but more so in areas adjacent to any web walls and within substrate walls.

Supporting ribs 1352 extend between a leading, distal end 1302 which inserted first into a bore and a trailing or anchor receiving end 1304. In one embodiment, four supporting ribs 1352 (four each) are provided but more or fewer ribs, and more or fewer shutters in each ring, may be used. In other embodiments, some sides need not include shutters and may be interleaved with sides containing shutters.

The embodiment of FIG. 13 has reduced the number of panels with cams and shutters to reduce the installation effort and prevent too much adhesive from coming out at any single location. The shutters 1316 are configured to open only along their open edge when the cam is activated whereas other embodiments herein are free on three sides. This provides more flow control and prevents the shutters from accidentally opening outward under pressure where adhesive can escape uncontrolled into void areas of the substrate. In addition, an adhesive is controlled so it can only escape in the solid sections of the substrate. Bores 1325 are provided in addition to the shutters to allow adhesive to extrude even if the shutters aren't activated properly due to mis-installation.

Notches 1310 are configured to be much larger than posts 1320 and sides 1321 and 1323 are relatively deep so that any adhesive that flows back up the screen due to flow restrictions in the screen can exit via notches 1310. The removable top cap 1327 may be tethered on the top end 1392 of the screen 1300, and bottom cap 1349 may or may not be tethered to the end 1304 of the screen. Bottom cap 1340 attaches by pressing it onto the notches 1310 at the bottom of the screen (in a manner similar to assembling several screens together) and removes by twisting if additional screens are needed. Internal axial ribs 1352a help guide and center the threaded rod and keep it from sagging in horizontal applications. Cams 1316 act as the activating device for the shutters and also hold the screen in place in the hole so it can't slip out in upwardly inclined and/or overhead holes.

In various embodiments, externally actuated shutter cams can be the same height/geometry or different over the length of the screen to control adhesive flow at distinct locations in the screen. Generally, embodiments herein with axially oriented shutters provide a long lever arm for easy hinging at the connection point, making insertion into the base material easier. Both allow adhesives with different viscosities and/or particle size to work in the same screen and controls adhesive flow throughout the entire length of the screen. Radial oriented shutters generally have a short lever arm to control adhesive flow more precisely but may increase the force for insertion into the base material. Shutter cams can act as barbs to retain the screen in overhead holes.

Each of screens 300, 400, 600, 700, 800, 1000, 1200 and 1300 may be fabricated as a single injection molded plastic part, thereby reducing manufacturing costs and significantly and simplify supply chain. Alternative materials may be used to manufacture the screens including sheet metal (e.g. steel, stainless steel, aluminum, or the like), cardboard, or any material of sufficient strength and pliability allow the shutter hinges to work properly, Each of screens 300, 400, 600, 700, 800, 1000, 1200 and 1300 are modular in that they may be connected to additional ones of respective anchor screens 300, 400, 600, 700, 800, 1000, 1200 and 1300 to provide varying lengths as needed and provide custom lengths. In embodiments, end caps are illustrated as integrally formed as part of the screen and/or separate but attachable to the body of the screen. Each screen embodiment herein may include an attached end cap or separate end cap. Moreover, integrally formed end caps may be removed in the field to allow connections between multiple screens. Although the connection structures are variously described as notches and posts herein, it should be understood that various different types of connection structures may be used with the technology described herein.

Each of screens 300, 400, 600, 700, 800, 1000, 1200 and 1300 is referred to herein as being generally cylindrical about a longitudinal axis A passing through the center of each of the cross-sections illustrated in FIGS. 3E, 4C, 7C, 8C, and 8E. However, certain embodiments (for example screens 400, 600, 700, 800, 1000, 1200 and 1300) are not entirely cylindrical since they either include sides on which the shutters are formed or include cross-sections defined by the shutters themselves which are not strictly a true circular cross-section. Each of screens 300, 400, 600, 700, 800, 1000, 1200 and 1300 is referred to herein as having a tubular shape—a three-dimensional geometric form that resembles a tube or cylinder, characterized by a hollow interior and one or more outer surfaces creating the generally cylindrical shape. Each of screens 300, 400, 600, 700, 800, 1000, 1200 and 1300 is generally symmetrical around the longitudinal axis A, with a cross-sectional area consistent along its length.

The terms “top” and “bottom,” “upper” and “lower” and “vertical” and “horizontal” as may be used herein are by way of example and illustrative purposes only and are not meant to limit the description of the invention since the referenced item can be exchanged in position and orientation. Also, as used herein, the terms “substantially” and/or “about” mean that the specified dimension or parameter may be varied within an acceptable manufacturing tolerance for a given application. In one embodiment, the acceptable manufacturing tolerance is ±2.5% of a stated dimension.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The foregoing detailed description has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A modular adhesive insert for an anchor assembly, comprising:
a housing with a first end and a second end, the first end including a first set of connection structures, the second end including a second set of connection structures, the housing including a plurality of shutters between the first end and the second end, each of the shutters adapted to vary a size of an opening associated with each said shutter.

2. The insert of claim 1 wherein at least a first subset of a plurality of apertures having a first sized opening and at least a second subset of the plurality of apertures having a second sized opening.

3. The insert of claim 1 further including a first end cap and a second end cap, the first set of connection structures adapted to connect to a first end cap and the second set of connection structures adapted to connect a second end cap to the housing.

4. The insert of claim 1 wherein each shutter has at least an open side, a second side opposing the open side and two sides defined by an indentation in the housing and positioned between the open side and second side.

5. The insert of claim 1 wherein each of the plurality of shutters includes an interior side and an exterior side, and a cam on the interior side of the shutter.

6. The insert of claim 1 wherein each of the plurality of shutters includes an interior side and an exterior side, and a cam on the exterior side of the shutter.

7. The insert of claim 1 wherein each shutter has at least a hinged side, a free end opposing the hinged side, and two free sides between the hinged side and the free end.

8. The insert of claim 7 wherein each of the plurality of shutters includes the hinged side perpendicular to a central axis of the housing such that each shutter opens along an axial length of the housing.

9. The insert of claim 7 wherein each of the plurality of shutters includes the hinged side parallel to a central axis of the housing such that each shutter opens along a radial length of the housing.

10. The insert of claim 9 wherein the housing includes a plurality of panels interleaved with the plurality of shutters, and wherein ones of the panels and ones of the shutters include apertures.

11. The insert of claim 1 wherein the first set of connection structures comprise posts and the second set of connection structures comprise notches.

12. A modular adhesive screen for an anchor insert assembly, comprising a body having a first end and a second end, and a length between the first end and the second end, the body having a tubular shape defined by one or more outer surfaces, the one or more outer surfaces including a plurality of shutters, each of the shutters configured to vary an opening associated with the shutter upon installation of the insert assembly.

13. The screen of claim 12 wherein each shutter has at least an open side, a second side opposing the open side and two sides defined by an indentation in the body and positioned between the open side and second side.

14. The screen of claim 12 wherein the shutters vary in size as the screen is screened into a bore in a substrate.

15. The screen of claim 14 wherein each of the plurality of shutters includes and interior side and an exterior side, and a cam on the exterior side of the shutter.

16. The screen of claim 12 wherein the anchor screen assembly includes an anchor rod inserted into the screen, and the shutters vary in size as the anchor rod is screened into the screen.

17. The screen of claim 16 wherein each of the plurality of shutters includes an interior side and an exterior side, and a cam on the interior side of the shutter.

18. The screen of claim 12 wherein each of the plurality of shutters has at least a hinged side, a free end opposing the hinged side, and two free sides between the hinged side and the free end.

19. The screen of claim 18 wherein each of the plurality of shutters includes the hinged side perpendicular to a central axis of the screen such that each shutter opens along an axial length of the screen.

20. The screen of claim 18 wherein the screen includes a plurality of panels interleaved with the plurality of shutters, and wherein ones of the panels and ones of the shutters include apertures.
